(19) United States
(12) Patent Application Publication
(10) Pub. No.: US 2012/0218253 A1
(43) Pub. Date: Aug. 30, 2012

(54) ADJUSTING 3D EFFECTS FOR WEARABLE VIEWING DEVICES

(75) Inventor: John Clavin, Seattle, WA (US)

(73) Assignee: MICROSOFT CORPORATION, Redmond, WA (US)

(21) Appl. No.: 13/036,498

(22) Filed: Feb. 28, 2011

(51) Int. Cl. G06T 15/00

(52) U.S. Cl. 345/419

(57) ABSTRACT

Various embodiments are disclosed that relate to displaying 3D effects for one or more wearable 3D viewing devices. For example, one disclosed embodiment provides a method which comprises, for each of one or more wearable 3D viewing devices, detecting a property of the wearable 3D viewing device, and for a 3D effect to be presented to users of the one or more wearable 3D viewing devices, adjusting presentation of the 3D effect based on the detected properties.

### BACKGROUND

Three-dimensional (3D) presentation of content, such as images, movies, videos, etc., to viewers may be performed in a variety of ways. For example, passive wearable 3D viewing devices, such as anaglyphic glasses (e.g., with separate red and cyan lenses) or polarized glasses, may be worn by a viewer of a display device configured to display off-set images to the viewer. As another example, active wearable 3D viewing devices, e.g., with shutter lenses, may be worn by a viewer of a display device configured to display alternate-frame sequences which are filtered by the shutter lenses. As another example, head mounted display devices (HMDs) with separate displays positioned in front of each eye may present 3D effects to the wearer. Further, in some examples, HMDs may have the capability to be configured to at least partially simulate active or passive 3D viewing devices. As still another example, autostereoscopy may be employed by a display device to display stereoscopic images to a viewer without the use of special headgear or glasses.

### SUMMARY

Various embodiments are disclosed that relate to displaying 3D effects for one or more wearable 3D viewing devices in a 3D presentation environment. Presentation of a 3D effect to users of one or more wearable 3D viewing devices in a 3D presentation environment is adjusted based on various detected properties of the one or more wearable 3D viewing devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example 3D presentation environment including viewers and a display device.

FIG. 2 shows an embodiment of a method for displaying 3D effects for one or more wearable 3D viewing devices.

FIG. 3 shows another embodiment of a method for displaying 3D effects for one or more wearable 3D viewing devices.

FIG. 4 shows a block diagram depicting an embodiment of a computing device in accordance with the disclosure.

### DETAILED DESCRIPTION

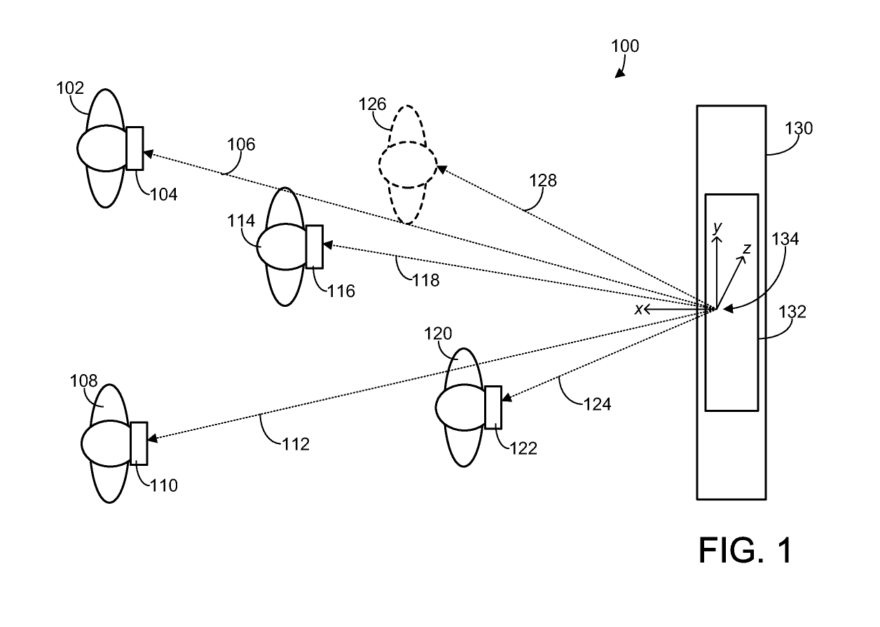

FIG. 1 shows an example 3D presentation environment 100 including viewers 102, 108, 114, 120, and 126 and a display device 130.

Display device 130 may be any suitable display device configured to present three-dimensional (3D) content to one or more viewers. For example, display device 130 may be a television, a computer monitor, a mobile display device, a billboard, a sign, a vending machine, etc.

Display device 130 may be configured to present 3D content to viewers in a variety of ways. For example, display device 130 may be configured to display off-set images to the viewers wearing passive 3D viewing devices, such as anaglyphic glasses (e.g., with separate red and cyan lenses) or polarized glasses. As another example, display device 130 may be configured to display alternate-frame sequences to viewers wearing active 3D viewing devices with shutter lenses. As still another example, display device 130 may be configured to directly display stereoscopic images to viewers who are not wearing special headgear or glasses.

Viewers in a 3D presentation environment, such as viewers 102, 108, 114, 120, and 126 shown in FIG. 1, may be wearing a variety of different types of wearable 3D viewing devices. For example, viewer 102 is a user of wearable 3D viewing device 104, viewer 108 is a user of wearable 3D viewing device 110, viewer 114 is a user of wearable 3D viewing device 116, and viewer 120 is a user of wearable 3D viewing device 122. In addition, in some examples, one or more viewers in a 3D presentation environment may not be wearing or using a wearable 3D viewing device. For example, viewer 126 shown in FIG. 1 is not wearing or using a wearable 3D viewing device.

Examples of types of wearable 3D viewing devices used by viewers in a 3D presentation environment include, but are not limited to, passive wearable 3D viewing devices, such as anaglyphic glasses (e.g., with separate red and cyan lenses) or polarized glasses, active wearable 3D viewing devices, e.g., shutter lenses, and head mounted display devices (HMDs) with separate displays positioned in front of each eye.

In some examples, head mounted display devices (HMDs) may have the capability to be configured to at least partially simulate active or passive 3D viewing devices. For example, an HMD device may be able to operate in transmissive modes wherein lenses of the HMD at least partially permit external light to pass through the lenses to a user's eyes. In simulating passive devices, the lenses in an HMD may be configured to filter external light by filtering color (in the case of simulating anaglyphic glasses) or by polarized filtering (in the case of simulating polarized glasses). In simulating active devices, transmissiveness of the lenses of an HMD may be alternately switched on and off to simulate shutter lenses. Further, an HMD may permit all external light to pass through the lenses when autostereoscopy is employed by a display device.

Further, there may be different models or versions of types of wearable 3D viewing devices which have different capabilities and optimal working conditions. For example, two viewers in FIG. 1 may be wearing different HMD devices with different capabilities and optimal working conditions. For example, some HMD devices may be able to simulate a passive or active 3D viewing device, whereas other HMD devices may not have the capability to simulate passive or active 3D viewing devices. Further, different HMD devices may have different resolutions, refresh rates, power settings, operating modes, etc.

In some cases, two or more of the viewers in FIG. 1 will be wearing active viewing devices (e.g., with shutter lenses). In this case, the devices might vary in terms of their capabilities or optical working conditions. For example, the shutter lenses of the devices might be set operate at different frequencies.

When a display device presents 3D effects to various different types of wearable 3D viewing devices with different capabilities in a presentation environment, in some examples, the 3D effects may not be perceivable by all such wearable 3D devices. For example, wearable 3D viewing device 116 used by viewer 114 may be an active viewing device and wearable 3D viewing device 122 used by viewer 120 may be a passive viewing device. In this example, if only off-set images are displayed to viewer 114 and viewer 120, then viewer 114 may not perceive the 3D effect.

In addition to the various types and capabilities of the wearable 3D viewing devices used by different viewers in a 3D presentation environment, various other factors or properties of wearable 3D viewing devices may affect if or how a 3D effect is perceived by the different viewers.

For example, the positioning of viewers in the environment relative to the display device may affect if or how a 3D effect is perceived by different viewers wearing different 3D viewing devices. As an example case, if wearable 3D viewing device 122 used by viewer 120 is a passive viewing device and wearable 3D viewing device 110 used by viewer 108 is also a passive viewing device, then since viewer 120 is closer to display device 130 than viewer 108, an amount of off-set in images displayed to viewer 108 may have to be less than an amount of off-set in images displayed to viewer 120 in order to provide an optimal 3D effect to both viewers. Alternatively, an amount of off-set presented to the viewers may be averaged so as to accommodate the different distances.

Other example properties of wearable 3D viewing devices which may affect if or how a 3D effect is perceived by the different viewers include whether or not a 3D viewing device is being worn by a viewer, whether or not a 3D viewing device is powered on, an optimal refresh rate of a 3D viewing device (e.g., when the 3D viewing device is an active viewing device), the polarization schema of polarized 3D glasses, an orientation of a viewer wearing a 3D viewing device, etc.

In order to optimize presentation of 3D effects in a 3D presentation environment with multiple viewers using various different wearable 3D devices with different properties, the 3D effect may be adjusted based on detected properties of the various different wearable 3D devices as described below.

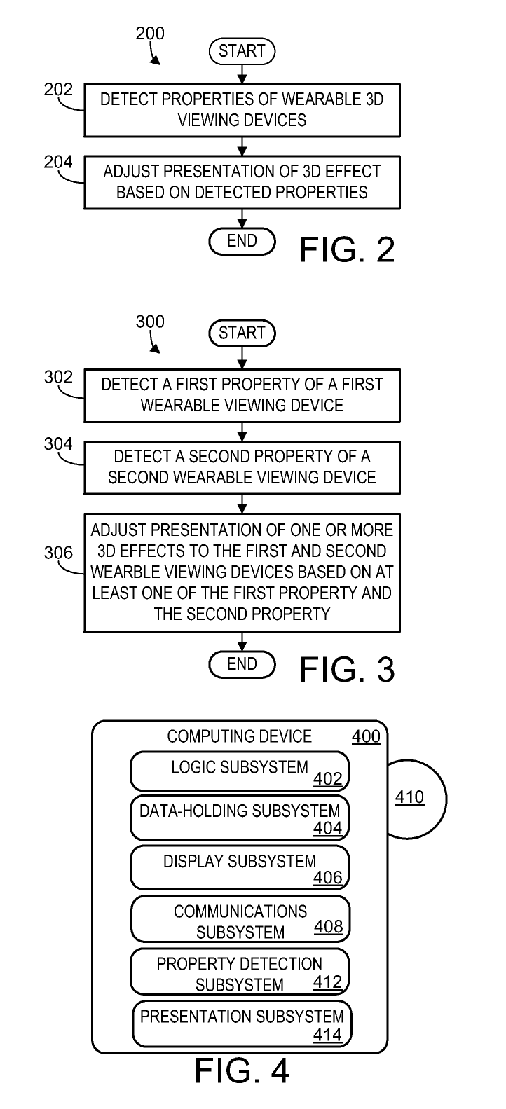

Turning now to FIG. 2, an embodiment of a method 200 for displaying 3D effects for one or more wearable 3D viewing devices is shown.

At 202, method 200 includes detecting properties of one or more wearable 3D viewing devices. Namely, for each of one or more wearable 3D viewing devices in a 3D presentation environment, a property of the wearable 3D viewing device may be detected.

One example of a property of a wearable 3D viewing device is the device type. For example, a wearable 3D viewing device may be a passive wearable 3D viewing device, such as anaglyphic glasses (e.g., with separate red and cyan lenses) or polarized glasses, an active wearable 3D viewing device, e.g., with shutter lenses, or a head mounted display device (HMD) with separate displays positioned in front of each eye. Additionally, in some examples, a viewer in a 3D presentation environment may not be wearing a 3D viewing device.

Thus, in some examples, detecting a property of the wearable 3D viewing device may include detecting a type of the wearable 3D viewing device, the type being one of a passive wearable 3D viewing device, an active wearable 3D viewing device, and a head mounted display device.

Another example of a property of a wearable 3D viewing device is a device capability. For example, different models or versions of types of wearable 3D viewing devices may have different capabilities and optimal working conditions. For example, different active 3D viewing devices may have different optimal shutter frequencies, different passive 3D viewing devices may function optimally at different distances from a display device, and different HMDs may have different simulation capabilities. For example, some HMDs may be capable of simulating passive and active devices whereas others may not have such capabilities. Thus, in some examples, detecting a property of the wearable 3D viewing device may include detecting a capability of the wearable 3D viewing device.

Yet another example of a property of a wearable 3D viewing device is a location of the wearable 3D viewing device in a 3D presentation environment. For example, a distance from a wearable 3D viewing device to a display device may affect if or how a 3D effect is perceivable by a user of the 3D viewing device. Thus, in some examples, detecting a property of the wearable 3D viewing device may include detecting a distance from the wearable 3D viewing device to a display device on which the 3D effect is presented.

Other example properties of wearable 3D viewing devices which may affect if or how a 3D effect is perceived by the different viewers include whether or not a 3D viewing device is being worn by a viewer, whether or not a 3D viewing device is powered on, an optimal refresh rate of a 3D viewing device (e.g., when the 3D viewing device is an active viewing device), the polarization schema of polarized 3D glasses, an orientation of a viewer wearing a 3D viewing device, etc.

Various approaches may be employed to detect properties of one or more wearable devices in a 3D presentation environment. For example, display device 130 may include a suitable sensor, such as a depth camera, an IR capture device, or any suitable sensor configured to detect properties of wearable 3D devices in an environment. In some examples, display device 130 may be coupled with or include a sensor device 132, e.g., a set-top box, console, or the like, which is configured to detect properties of wearable 3D viewing devices in an environment.

Various protocols may be employed in conjunction with a suitable sensor to detect properties of one or more wearable 3D viewing devices in an environment. For example, facial recognition or machine vision software may be used to identify types of wearable 3D viewing devices, or whether a particular user is not wearing a viewing device. As another example, a depth camera may capture a depth map of the environment and use skeletal tracking to detect position information, distances, and types of wearable 3D devices used by viewers in the environment. For example, as shown in FIG. 1, 3D coordinates (e.g., x, y, z coordinates) relative to an origin 134 at sensor device 132 may be detected and used to determine distances 106, 112, 118, 124, and 128 from viewers 102, 108, 114, 120, and 126, respectively.

In some examples, one or more of the wearable 3D viewing devices in the environment may actively communicate signals to the display device or sensor device indicating their properties or states, e.g., whether they are powered on or off, power levels, what their capabilities are, optimal refresh rates, optimal viewing distance, etc.

In some examples, one or more of the wearable 3D viewing devices in the environment may passively communicate signals to the display device or sensor device indicating their properties or states. For example, one or more wearable 3D viewing devices in an environment may include reflective tags, e.g., IR tags, Mobi tags, or the like, which include property information accessible to the display device or sensor device.

Thus, in some examples, detecting a property of the wearable 3D viewing device may include receiving a communication from the wearable 3D viewing device, where the communication indicates a property of the wearable 3D viewing device. For example, a 3D viewing device may actively or passively transmit property information to a display device or sensor device.

At 204, method 200 includes, for a 3D effect to be presented to users of the one or more wearable 3D viewing devices, adjusting presentation of the 3D effect based on the detected properties.

Many different scenarios are possible. For example, if all viewers in a 3D presentation environment are using HMD devices, then a 3D effect may be adapted for immersive presentation on all the HMD devices appropriate to their individual capabilities. Namely, in this example, the system may present 3D effects directly to the lenses in the HMD devices. Each HMD device may be presented with 3D effects adjusted based on specific capabilities of the HMD device. For example, refresh rates, resolutions, etc. may be specifically adjusted based on the HMD device capabilities and status.

As another example, if one viewer is using an HMD device and another viewer is using a passive viewing device, then the HMD device may simulate the passive viewing device if capable. For example, the HMD may simulate anaglyphic glasses (e.g., with separate red and cyan lenses) or polarized glasses so that the 3D effect is presented to both viewers on the separate display device. As another example, if one viewer is using an HMD device and another viewer is using an active viewing device, then the HMD device may simulate the active viewing device if capable. Alternatively, the HMD may operate in an immersive mode rather than simulating other devices.

As still another example, if a viewer is not wearing a 3D viewing device and another viewer is wearing a HMD device, then an immersion presentation of a 3D effect may be provided to the HMD device and a 3D effect may be presented to the viewer who is not wearing a viewing device directly from the display device. In other examples, if a viewer is not wearing a 3D viewing device, then a two-dimensional (2D) presentation may be provided to the viewer.

As still another example, if viewers wearing passive viewing devices are at different distances from the display device, adjusting presentation of the 3D effect based on the detected properties may include adjusting an image offset amount to account for the different distances. Alternatively, the 3D effect presentation may be adjusted to an average, e.g., an average offset amount, in order to present a common 3D effect to the viewers. In general, when a 3D effect is presented on a display screen separate from the viewing devices (e.g., display device 130), the presentation may be adjusted to the lowest common property/ability so that the 3D effect is perceivable by all users.

Additionally, in some examples, viewers in a 3D presentation environment may move positions or change the type of viewing devices they are using. Thus, detection of properties of wearable 3D viewing device may be performed constantly, in real time, or periodically so that the 3D effect(s) presented to viewers may be dynamically updated based on updated properties of the wearable 3D viewing devices in the environment.

The present methods can be employed in the case of a single wearable device, though they will often be employed in a setting with multiple devices. FIG. 3 specifically addresses the case of multiple devices and shows another embodiment of a method 300 for displaying 3D effects for one or more wearable 3D viewing devices.

At 302, method 300 includes, for a first wearable 3D viewing device, detecting a first property of the first wearable 3D viewing device. At 304, method 300 includes, for a second wearable 3D viewing device, detecting a second property of the second wearable 3D viewing device, where the second property is different from the first property.

For example, one of the first property and the second property may be a distance from a display device that is separate from the first wearable 3D viewing device and the second wearable 3D viewing device. In such a case, the distance may affect how a 3D effect is perceived by users of the first and/or second wearable 3D viewing devices.

At 306, method 300 includes, for one or more 3D effects to be presented to the first wearable 3D viewing device and the second wearable 3D viewing device, adjusting presentation of such one or more 3D effects based on at least one of the first property and the second property.

In some examples, adjusting presentation of the one or more 3D effects may include presenting a first 3D effect to a user of the first wearable 3D viewing device and presenting a second 3D effect to a user of the second wearable 3D viewing device, the first 3D effect being different from the second 3D effect. For example, the first wearable 3D viewing device may be a head mounted display, with the first 3D effect being adapted for immersive presentation on such head mounted display, and the second 3D effect may be adapted for presentation on a display device that is separate from the first wearable 3D viewing device and the second wearable 3D viewing device. Further, in some examples, the first 3D effect may differ from the second 3D effect based on detecting that the first wearable 3D viewing device and the second wearable 3D viewing device differ in capability. Additionally, in some examples, adjusting presentation of such one or more 3D effects may include presenting a single 3D effect that is perceivable using either of the first wearable 3D viewing device and the second wearable 3D viewing device.

In this way, display of 3D effects and content may be automatically adjusted based on properties of wearable 3D devices in a 3D presentation environment. For example, presentation of a 3D effect may be adjusted based on a predominance of multiple viewers either wearing or not wearing 3D glasses, or wearing one type of viewing device versus another. For example, if there are multiple people viewing the content, the system may determine the number of people wearing a first type of 3D viewing device versus the number of people wearing a second type of 3D viewing device and display content accordingly.

FIG. 4 schematically shows a nonlimiting computing device 400 that may perform one or more of the above described methods and processes. Computing device 400 may represent any of display device 130, sensor device 132, or wearable 3D viewing devices 104, 110, 116, and 122.

Computing device 400 is shown in simplified form. It is to be understood that virtually any computer architecture may be used without departing from the scope of this disclosure. In different embodiments, computing device 400 may take the form of a mainframe computer, server computer, desktop computer, laptop computer, tablet computer, home entertainment computer, network computing device, mobile computing device, mobile communication device, gaming device, etc.

Computing device 400 includes a logic subsystem 402 and a data-holding subsystem 404. Computing device 400 may optionally include a display subsystem 406, communication subsystem 408, property detection subsystem 412, presentation subsystem 414, and/or other components not shown in FIG. 4. Computing device 400 may also optionally include user input devices such as keyboards, mice, game controllers, cameras, microphones, and/or touch screens, for example.

Logic subsystem 402 may include one or more physical devices configured to execute one or more instructions. For example, the logic subsystem 402 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 402 may include one or more processors that are configured to execute software instructions. Additionally or alternatively, logic subsystem 402 may include one or more hardware or firmware logic machines configured to execute hardware or firmware instructions. Processors of logic subsystem 402 may be single core or multicore, and the programs executed thereon may be configured for parallel or distributed processing. The logic subsystem may optionally include individual components that are distributed throughout two or more devices, which may be remotely located and/or configured for coordinated processing. One or more aspects of logic subsystem 402 may be virtualized and executed by remotely accessible networked computing devices configured in a cloud computing configuration.

Data-holding subsystem 404 may include one or more physical, non-transitory, devices configured to hold data and/or instructions executable by logic subsystem 402 to implement the herein described methods and processes. When such methods and processes are implemented, the state of data-holding subsystem 404 may be transformed (e.g., to hold different data).

Data-holding subsystem 404 may include removable media and/or built-in devices. Data-holding subsystem 404 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 404 may include devices with one or more of the following characteristics: volatile, nonvolatile, dynamic, static, read/write, read-only, random access, sequential access, location addressable, file addressable, and content addressable. In some embodiments, logic subsystem 402 and data-holding subsystem 404 may be integrated into one or more common devices, such as an application specific integrated circuit or a system on a chip.

FIG. 4 also shows an aspect of the data-holding subsystem in the form of removable computer-readable storage media 410, which may be used to store and/or transfer data and/or instructions executable to implement the herein described methods and processes. Removable computer-readable storage media 410 may take the form of CDs, DVDs, HD-DVDs, Blu-Ray Discs, EEPROMs, and/or floppy disks, among others.

Display subsystem 406 may be used to present a visual representation of data held by data-holding subsystem 404. As the herein described methods and processes change the data held by the data-holding subsystem, and thus transform the state of the data-holding subsystem, the state of display subsystem 406 may likewise be transformed to visually represent changes in the underlying data. Display subsystem 406 may include one or more display devices utilizing virtually any type of technology. Such display devices may be combined with logic subsystem 402 and/or data-holding subsystem 404 in a shared enclosure, or such display devices may be peripheral display devices.

Communication subsystem 408 may be configured to communicatively couple computing device 400 with one or more other computing devices. Communication subsystem 408 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing device 400 to send and/or receive messages to and/or from other devices via a network such as the Internet.

Property detection subsystem 412 may be embodied or instantiated by instructions executable by the logic subsystem to detect properties of one or more wearable 3D viewing devices in a 3D presentation environment as described above. Likewise, presentation subsystem 414 may be embodied or instantiated by instructions executable by the logic subsystem to adjust and present 3D effect to users of wearable 3D devices in a 3D presentation environment based on detected properties as described above.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for displaying 3D effects for one or more wearable 3D viewing devices, comprising:
for each of the one or more wearable 3D viewing devices, detecting a property of the wearable 3D viewing device; and
for a 3D effect to be presented to the one or more wearable 3D viewing devices, adjusting presentation of the 3D effect based on the detected property.

2. The method of claim 1, wherein detecting a property of the wearable 3D viewing device includes detecting a distance from the wearable 3D viewing device to a display device on which the 3D effect is presented.

3. The method of claim 1, wherein detecting a property of the wearable 3D viewing device includes detecting a type of the wearable 3D viewing device.

4. The method of claim 3, wherein the type is one of a passive wearable 3D viewing device, an active wearable 3D viewing device, and a head mounted display device.

5. The method of claim 1, wherein detecting a property of the wearable 3D viewing device includes detecting a capability of the wearable 3D viewing device.

6. The method of claim 1, wherein detecting a property of the wearable 3D viewing device includes receiving a communication from the wearable 3D viewing device, the communication indicating the property of the wearable 3D viewing device.

7. The method of claim 1, wherein adjusting presentation of the 3D effect includes, in a setting with multiple different types of wearable 3D viewing devices, presenting the 3D effect so it is perceivable by all such wearable 3D devices.

8. The method of claim 1, further comprising, in a setting with multiple different types of wearable 3D viewing devices, presenting a first 3D effect to one type of wearable 3D viewing device, and another, different, 3D effect to another type of wearable 3D viewing device.

9. The method of claim 1, wherein the one or more wearable 3D viewing devices includes a first wearable 3D viewing device and second wearable 3D viewing device, and wherein adjusting presentation of the 3D effect includes adjusting a 3D effect presented to the first wearable 3D viewing device based on a capability of the second wearable 3D viewing device.

10. A method for displaying 3D effects for one or more wearable 3D viewing devices, comprising:
for a first wearable 3D viewing device, detecting a first property of the first wearable 3D viewing device;
for a second wearable 3D viewing device, detecting a second property of the second wearable 3D viewing device, the second property being different from the first property; and
for one or more 3D effects to be presented to the first wearable 3D viewing device and the second wearable 3D viewing device, adjusting presentation of such one or more 3D effects based on at least one of the first property and the second property.

11. The method of claim 10, wherein adjusting presentation of the one or more 3D effects includes presenting a first 3D effect to a user of the first wearable 3D viewing device and presenting a second 3D effect to a user of the second wearable 3D viewing device, the first 3D effect being different from the second 3D effect.

12. The method of claim 11, wherein the first 3D effect differs from the second 3D effect based on detecting that the first wearable 3D viewing device and the second wearable 3D viewing device differ in capability.

13. The method of claim 11, wherein the first wearable 3D viewing device is a head mounted display, with the first 3D effect being adapted for immersive presentation on such head mounted display, and wherein the second 3D effect is adapted for presentation on a display device that is separate from the first wearable 3D viewing device and the second wearable 3D viewing device.

14. The method of claim 10, wherein one of the first property and the second property is a distance from a display device that is separate from the first wearable 3D viewing device and the second wearable 3D viewing device.

15. The method of claim 10, wherein adjusting presentation of such one or more 3D effects includes presenting a single 3D effect that is perceivable using either of the first wearable 3D viewing device and the second wearable 3D viewing device.

16. A computing device, comprising:
a logic subsystem; and
a data holding subsystem comprising machine-readable instructions stored thereon that are executable by the logic subsystem to:
for each of the one or more wearable 3D viewing devices, detect a property of the wearable 3D viewing device; and
for a 3D effect to be presented to the one or more wearable 3D viewing devices, adjust presentation of the 3D effect based on the detected property.

17. The computing device of claim 16, wherein detecting a property of the wearable 3D viewing device includes one or more of detecting a distance from the wearable 3D viewing device to a display device on which the 3D effect is presented, detecting a type of the wearable 3D viewing device, and detecting a capability of the wearable 3D viewing device.

18. The computing device of claim 16, wherein the machine-readable instructions further executable by the logic subsystem to receive a communication from a wearable 3D viewing device to detect the property of the wearable 3D viewing device.

19. The computing device of claim 16, wherein adjusting presentation of the 3D effect includes, in a setting with multiple different types of wearable 3D viewing devices, presenting the 3D effect so it is perceivable by all such wearable 3D devices.

20. The computing device of claim 16, wherein the machine-readable instructions are further executable to, in a setting with multiple different types of wearable 3D viewing devices, present a first 3D effect to one type of wearable 3D viewing device, and another, different, 3D effect to another type of wearable 3D viewing device.
